(19) United States
(12) Patent Application Publication
(10) Pub. No.: US 2005/0100710 A1
(43) Pub. Date: May 12, 2005

(54) Flameproof environmentally friendly artificial leather and process for making the same

(75) Inventors: Chung-Chih Feng, Sanmin Chiu (TW); Pei-Huo Huang, Nantz Chiu (TW); Yong-Song Lin, Dashe Shiang (TW)

Correspondence Address: NIKOLAI & MERSEREAU, P.A., 900 SECOND AVENUE SOUTH, SUITE 820, MINNEAPOLIS, MN, 55402, US

(73) Assignee: San Fang Chemical Industry Co., LTD., Kaohsiung (TW)

(21) Appl. No.: 10/984,034

(22) Filed: Nov. 9, 2004

(30) Foreign Application Priority Data
Nov. 10, 2003 (TW) 092137342

(51) Int. Cl. B29C 41/22; B32B 31/00

(52) U.S. Cl. 428/151; 264/255; 264/257; 156/289; 156/247; 156/331.7; 428/904

(57) ABSTRACT

Flame-proof environmentally friendly artificial leather includes a substrate, an adhesive layer, an intermediate layer and a surface layer. The artificial leather is characterized in including the intermediate layer made of a high solid-content polyurethane resin compound added with a chlorine-free flame-proof agent. The high solid-content polyurethane resin compound is made through mixing the chlorine-free flame-proof agent, polyurethane resin with a solid-content higher than 50% and a curing agent. Moreover, a process is disclosed for making the flame-proof environmentally friendly artificial leather.

### BACKGROUND OF INVENTION

1. Field of Invention

The present invention relates to flameproof environmentally friendly artificial leather and a process for making the same.

2. Related Prior Art

Referring to FIG. 1, a conventional process for making realistic artificial leather includes two sub-routines 100 and 101. The sub-routine 100 is called “dry process.” The sub-routine 101 is called “wet process.” The dry process 100 includes two steps 102 and 104. Firstly, releasing paper is coated with dry polyurethane resin compound in order to form a dry polyurethane resin layer with thickness of 0.02 mm to 0.03 mm (step 102). Then, the dry polyurethane resin layer is coated with polyurethane resin compound in order to form an adhesive layer with thickness of 0.04 mm to 0.05 mm (step 104). The wet process 101 includes four steps 106 to 114. Firstly, a substrate is submerged in soaking polyurethane resin compound in order to form a submerged layer in the substrate (step 106). Secondly, coating polyurethane resin compound is coated on the substrate (step 108). Thirdly, the coating is coagulated (step 110). Fourthly, the coating is washed (step 112). Thus, a foam layer is formed on the substrate. Then, the adhesive layer of the product of the dry process 100 is adhered to the foam layer of the process of the wet process 101 (step 114). Finally, the releasing paper is removed (step 116). Thus, realistic artificial leather is made.

However, the dry polyurethane resin and adhesive polyurethane resin used in the dry process 100 and the soaking polyurethane resin and coating polyurethane resin used in the wet process 101 all contain a large amount of organic solvent such as methyl ethyl ketone (MEK), N,N-dimethylformmamide (DMF) and toluene (TOL).

When the dry polyurethane resin layer is formed and when the adhesive layer is coagulated, a step of drying must be taken in order to vaporize the organic solvent originally contained in the compound. The submerged layer and the foam layer must be submerged in organic solvent and water alternatively so that the organic solvent is dissolved in the water and recycled. The organic solvent is poison that is chronically hazardous to human bodies and pollutant to the environment. The organic solvent is easily flammable and can easily be set on fire when handled a little carelessly.

Currently, to obviate the problem of the pollution by the organic solvent, the water-dissolvable polyurethane resin layer coated on the releasing paper is directly adhered to non-woven cloth or cloth. However, the resultant artificial leather does not possess the thickness and elasticity of genuine leather and hence provides lousy feel and durability. Further, the resultant artificial leather could not provide a touch as genuine leather. Moreover, to improve the feel of the artificial leather made of the water-dissolvable polyurethane layer, the water-dissolvable polyurethane layer coated on the releasing paper is directly adhered to the wet half-product of the artificial leather with the foam layer. However, a large number of organic solvent is still used in the process for making the wet half-product of the artificial leather such as the wet process 101. Although the process for making the adhesive layer of the artificial leather is environmentally friendly, environmental pollution still occurs because a large number of organic solvent is still used in the process for making the wet half-product of the artificial leather.

Furthermore, because a large number of organic solvent is used in the process, the artificial leather generally contains organic residual. Additionally, because the polyurethane resin is flammable, the artificial leather is not flameproof and can be burned when in contact with fire. Since much artificial leather is used in furniture, medical equipment, vehicle interior, there is an urgent need for flameproof artificial leather for the safety of users.

Generally, chlorine is added to polyurethane resin in order to improve the flame-resistance of artificial leather. However, chlorine is poisonous so that the cost of environmental protection is high in making, using, recycling and burning the artificial leather. Therefore, artificial leather added with chlorine is to be phased out.

### SUMMARY OF INVENTION

It is an objective of the present invention to provide a process for making flameproof environmentally friendly artificial leather in order to significantly reduce the amount of organic solvent used in the process and to render the artificial leather flameproof.

It is another objective of the present invention to provide a process for making flameproof environmentally friendly artificial leather in order to render the artificial leather durable, and realistic. Further, the resultant artificial leather is thick and solid as genuine leather and provides a touch as genuine leather.

In order to achieve the above-mentioned and other objectives, the present invention provides a process for making flameproof environmentally friendly artificial leather. Firstly, releasing paper is coated with a first kind of polyurethane resin compound in order to form a surface layer with thickness of 0.02 mm to 0.2 mm. Then, high solid-content polyurethane resin compound is coated on the surface layer in order to form an intermediate layer with thickness of 0.1 mm to 3 mm. The high solid-content polyurethane resin compound is mixture of chlorine-free flameproof agent, polyurethane resin compound with solid-content higher than 50% and curing agent. Then, the intermediate layer is coated with a second kind of polyurethane resin compound in order to form an adhesive layer. A substrate with thickness of 0.5 mm to 3 mm is adhered to the adhesive layer. Finally, the releasing paper is removed. Thus, the flameproof environmentally friendly artificial leather is made.

Polyurethane resin compound used in the present invention includes no or only a little organic solvent. It may be water-dissolvable polyurethane resin compound or water dispersed polyurethane resin compound. In the process, such polyurethane resin compound releases only a little or no organic solvent in order to achieve the purposes of environmental protection.

The present invention is characterized in adding such chlorine-free flameproof agent to the high solid-content poly-urethane resin compound in order to form an intermediate layer much thicker than the surface layer and the adhesive layer. The high solid-content polyurethane resin compound contains little organic solvent so that the added flameproof agent works well. Its thickness changes only a little before and after it is dried. The intermediate layer is made thick easily in order to exhibit the volume feeling and durability of genuine leather.

The present invention provides another process for making flameproof environmentally friendly artificial leather. Mixture of 10% to 40% of polyol, 15% to 25% of isocyanate 15% to 35% chain-extending agent and chlorine-free flameproof agent is made. The mixture is put in an impact-type mixing head of a reactive injection molding apparatus at a temperature of −20° C. to 60° C. Reverse operation is conducted in order to damp the reactive injection molding. The esterification of the mixture in the impact-type mixing head is damped. The gradients are pre-polymerized in order to form precursor of polyurethane. Then, 15% to 25% of isocyanate may be added in the impact-type mixing head in order to form the precursor of the polyurethane (the isocyanatesindex NCO/OH is 0.9 to 1.2). Then, coating is conducted under injection pressure of lower than 4 kgf/cm2. Thus, the precursor is spread fully spread on the releasing paper. Then, the precursor is heated in a stove kept at a temperature of 70° C. to 180° C. in order to form the polyurethane resin. When the polyurethane resin is still sticky, a substrate is adhered to the polyurethane resin. Then, the polyurethane resin is heated in the stove so that it is coagulated and that a half-product of the flameproof environmentally friendly artificial leather is made. Finally, the releasing paper is removed from the polyurethane resin. Thus, the flameproof environmentally friendly artificial leather is made. In the present invention, reactive injection molding is used to make the polyurethane resin compound, and reverse operation is conducted in order to damp the reactive injection molding. The precursor is spread on the releasing paper under substantially no pressure instead of heavy pressure. Then, the precursor is heated and coagulated in a baker so that it is transformed into the polyurethane resin layer. It takes only 2 to 3 minutes to finish the reaction. In this process, the high solid-content polyurethane resin compound is made without using any solvent.

### BRIEF DESCRIPTION OF DRAWINGS

The present invention will be described via detailed illustration of embodiments referring to the drawings.

FIG. 1 is a flowchart of a conventional process for making artificial leather.

FIG. 2 is flowchart of a process for making flameproof environmentally friendly artificial leather according to a first embodiment of the present invention.

FIGS. 3a to 3e are cross-sectional views of artificial leather made according to the process shown in FIG. 2.

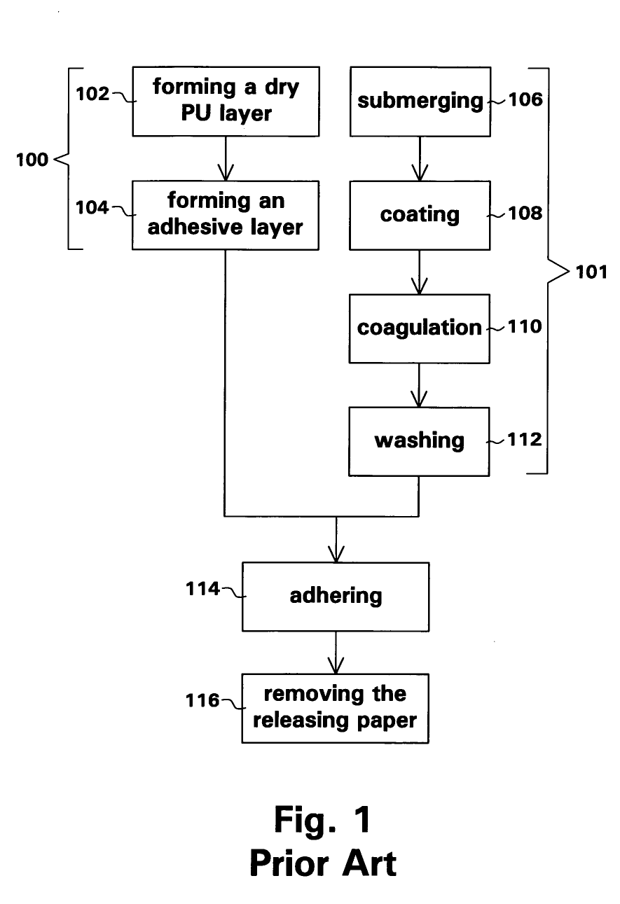

### DETAILED DESCRIPTION Of EMBODIMENTS

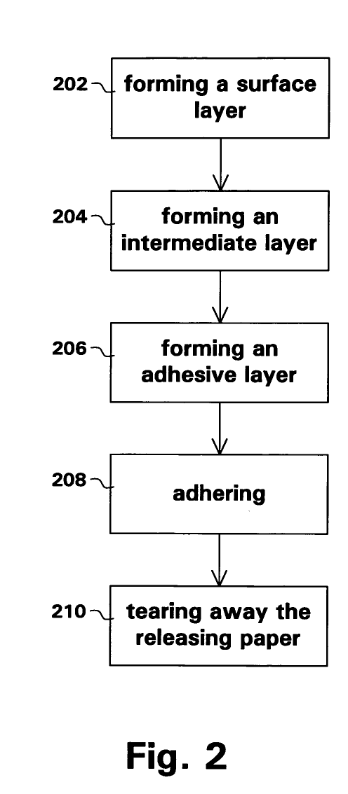

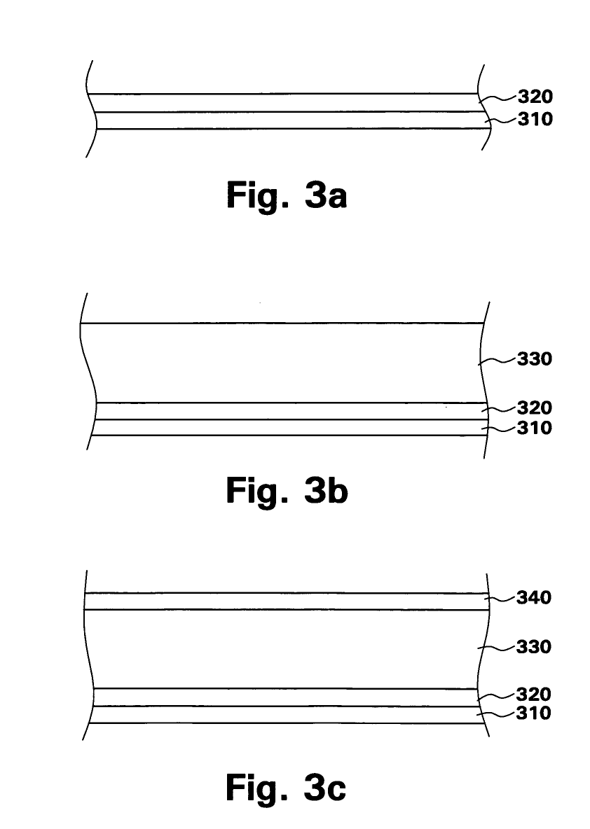

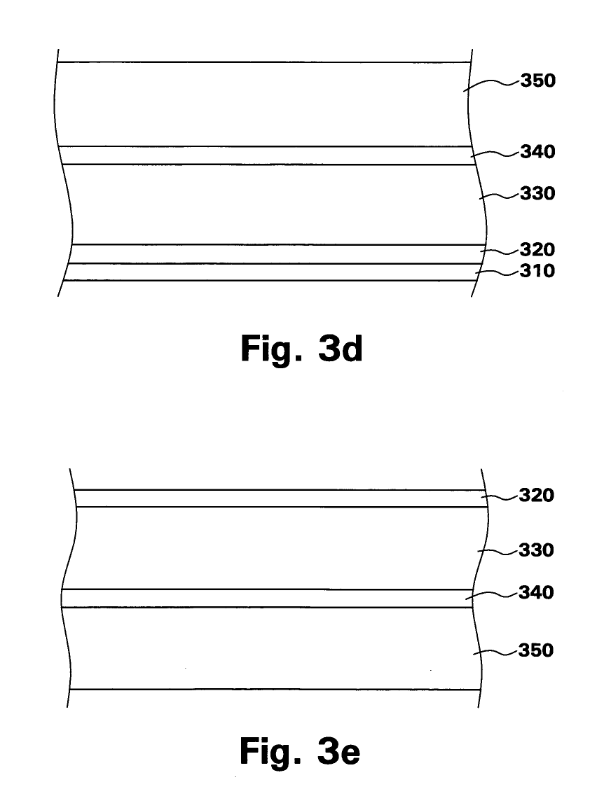

Referring to FIGS. 2 and 3a to 3e, a process for making flameproof environmentally friendly artificial leather according to the present invention will be described.

Firstly, at step 202 (referring to FIG. 3a), polyurethane resin compound is coated on releasing paper 310 and baked in order to form a surface layer 320. At step 204 (referring to FIG. 3b), chlorine-free high solid-content polyurethane resin compound is coated on the surface layer 320 and baked in order to form an intermediate layer 330. At step 206 (referring to FIG. 3c), polyurethane resin compound is coated on the intermediate layer 330, and baked and coagulated in order to form an adhesive layer 340. At step 210 (referring to FIG. 3e), the releasing paper 310 is removed in order to make flameproof environmentally friendly artificial leather.

In the present invention, polyurethane resin compound is used to form the surface layer 320 and the adhesive layer 340. The polyurethane resin compound that can be used to form the surface layer 320 is solvent-type polyurethane, water-dissolvable polyurethane resin compound or water-dispersed polyurethane resin compound. The polyurethane resin compound that can be used to form the adhesive layer 340 is solvent-type polyurethane, water-dissolvable polyurethane resin compound, water-dispersed polyurethane resin compound or solvent-free vapor-coagulated polyurethane resin. Appropriate water-dissolvable polyurethane resin may be solvent-free water-dissolvable polyurethane resin IMPRANIL DLS made by Bayer Chemical Co. Ltd. Appropriate water-dispersed polyurethane resin compound may be IMPRANIL DLP made by Bayer Chemical Co. Ltd.

The elastomeric solid content of the polyurethane resin compound used to form the surface 320 may be 10% to 90% and 35% to 60% is preferred. The polyurethane resin compound is baked at a temperature of 80° C. to 140° C. in order to form a surface layer 320 with thickness of 0.02 mm to 0.2 mm.

It should be noted that the chlorine-free flameproof high solid-content polyurethane is made by mixing chlorine-free flameproof agent, polyurethane with solid content of more than 50% and curing agent. The intermediate layer 330 (the thickness is 0.2 mm to 3 mm) is much thicker than the surface 320 and the adhesive layer 340. Thus, it is volume-feeling and elastic. The appropriate high solid-content polyurethane resin may be polyurethane resin with solid content of more than 50% and more preferably PU resin with solid content of more than 93%. More specifically, the high solid-content polyurethane resin compound includes 65% to 85% of polyurethane with solid content of 93% to 98%, 0% to 2% of interface agent, 3% to 7% of curing agent, 0% to 10% of dye and 10% to 25% chlorine-free flame-proof agent. The high solid-content polyurethane resin compound includes the interface agent in order to achieve excellent flatness and floating of the surfaces of the intermediate layer. The flameproof agent may be antimony-containing flameproof agent, phosphorous flameproof agent, calcium carbonate, clay or any mixture thereof.

The high solid-content (more than 93%) polyurethane resin compound includes a little organic solvent (less than 7%). Hence, in making the intermediate layer 330, not a large amount of organic solvent vaporizes so that the flameproof agent can fulfill its function. In a conventional process, artificial leather is not made of high solid-content polyurethane resin compound and a large amount of organic solvent is required and organic solvent residues in the artificial leather easily so that the artificial leather can be burned easily. Hence, even flameproof agent is added to the polyurethane resin compound in the conventional process, the chlorine-free flameproof agent cannot fulfill its function because of the residual organic solvent. Hence, those skilled in the art would not add anything other than chlorine-containing flameproof agent to the polyurethane resin compound.

Moreover, the thickness of the thickness of the high solid-content polyurethane resin compound changes only a little before and after it is dried. Therefore, the intermediate layer is made thick easily in order to exhibit the volume-feeling and durability of genuine leather.

The high solid-content polyurethane resin compound is baked at a temperature of 100° C. to 200° C. in order to form the intermediate layer 330. Moreover, foaming agent can be added to the high solid-content polyurethane resin compound in order to render the intermediate layer 330 porous. Preferably, the high solid-content polyurethane resin compound is vacuum deaerated before it is coated.

The substrate 350 is adhered to the adhesive layer 340 before the adhesive layer 340 is dried. Alternately, the substrate 350 is adhered to the adhesive layer 340 when the adhesive layer 340 is dried a little and remains sticky. As the substrate 350 is adhered to the adhesive layer 340, a half-product of the flameproof environmentally friendly artificial leather is made. Preferably, the half-product of the flameproof environmentally friendly artificial leather is put in a curing chamber for 24 hours to 48 hours so that the adhesive layer 340 forms a net-shaped bridge. In the present invention, the substrate 350 may be cloth, non-woven cloth or animal leather. The thickness of the substrate 350 is 0.5 mm to 3 mm. The substrate 350 can be processed with 5% to 50% water-based flame-resisting agent in order to improve the flameproof ability of the artificial leather.

Referring to FIG. 3e, the flameproof environmentally friendly artificial leather made in the foregoing process includes a substrate 350, an adhesive layer 340, an intermediate layer 330 and a surface layer 320. The flameproof environmentally friendly artificial leather is characterized in that between the surface layer 320 and the adhesive layer 340, the intermediate layer 330 is formed of high solid-content polyurethane resin compound to which chlorine-free flameproof agent is added.

The present provides another process for making flameproof environmentally friendly artificial leather. The process comprising all the steps disclosed in Taiwan Patent No. 275637. The present invention provides another process for making flameproof environmentally friendly artificial leather. Mixture of 10% to 40% of polyol, 15% to 25% of isocyanate 15% to 35% chain-extending agent and chlorine-free flameproof agent is made. The mixture is put in an impact-type mixing head of a reactive injection molding apparatus at a temperature of −20° C. to 60° C. Reverse operation is conducted in order to damp the reactive injection molding. The esterification of the mixture in the impact-type mixing head is damped. The gradients are pre-polymerized in order to form precursor of polyurethane. Then, 15% to 25% of isocyanate may be added in the impact-type mixing head in order to form the precursor of the polyurethane (the isocyanates index NCO/OH is 0.9 to 1.2). Then, coating is conducted under injection pressure of lower than 4 kgf/cm2. Thus, the precursor is spread fully spread on the releasing paper. Then, the precursor is heated in a stove kept at a temperature of 70° C. to 180° C. in order to form the polyurethane resin 05 mm to 3 mm thick. When the polyurethane resin is still sticky, a substrate is adhered to the polyurethane resin. Then, the polyurethane resin is heated in the stove so that it is coagulated and that a half-product of the flameproof environmentally friendly artificial leather is made. Finally, the releasing paper is removed from the polyurethane resin. Thus, the flameproof environmentally friendly artificial leather is made.

In the present invention, the polyol may be polyoxy alkylene polyol with unsaturated of less than 0.05 meq/g and more preferably less than 0.03 meq/g and most preferably less than 0.025 meq/g. The molecular number of the polyoxy alkylene polyol is 1000 to 3000 and more preferably 1500 to 2000. The hydroxy number·mgKOH/g·of each molecule is 1.2 to 2.0. The polyoxy alkylene polyol may be mixture of more than two gradients.

In the present invention, the isocyanate may be diphenylmethanediisocynate (MDI), tolulenediisonate (TDI), modifer thereof or mixture thereof. The chain-extending agent may be ethylene golycol, 1.4-butanediol, neopentyl glycol, 1.6-hexanediol, diethylene glycol, triethylene glycol, dipropylene glycol, triethanolamine, N-diethanolamide, N-alkyldiethylamino, or mixtures thereof.

The following embodiments are given in order to further describe the present invention, not limit the scope of the present invention.

### First Embodiment

Releasing paper is coated with a layer of polyurethane resin with solid content of 12.5% (including 87.5% of solvent). The stickiness of the polyurethane resin is controlled at 1300 cps/30° C. The polyurethane resin is baked in a stove at a temperature of 110° C. in order to form a surface layer.

High solid-content polyurethane resin is coated on the surface layer. The high solid-content polyurethane resin includes 67% of polyurethane resin (with solid content of 83%), 20% of phosphorous flameproof agent and Sb₂O₃ (phosphorous: Sb₂O₃ is 2:1), 1% of interface agent, 4% of curing agent, 6% of filling agent and 2% of dye. The stickiness of the high solid-content polyurethane resin is controlled at 25000 cps/30° C. The polyurethane resin is baked in a stove at a temperature of 160° C. in order to form an intermediate layer.

Polyurethane resin with solid content of 35% is coated on the intermediate layer in order to form an adhesive layer. The polyurethane resin of the adhesive layer is dried a little in the stove. When the adhesive layer is still sticky, a layer of 100% PET that is made with thickness of 1.0 mm and processed with water-based flameproof agent is adhered to it. The polyurethane resin of adhesive layer is dried in the stove. Then, the releasing paper is removed by means of a cooling wheel. Thus, artificial leather that possesses volume feeling, high peeling strength and high flexibility and is flameproof is made.

Table 1 shows comparison of the artificial leather of the present invention with the artificial leather discussed in Related Prior Art.

TABLE 1

| | | Present | |
|---|---|---|---|
| | Prior Art | Invention | Test Standard |
| Tensile Strength | More than 28 | 32 | ASTM D1682-D1117 |
| kg/cm | More than 10 | 22 | |
| Elongation % | More than 80 | 95 to 105 | ASTM D1682-D1117 |
| | More than 120 | 150 to 160 | |
| Tearing Strength | More than 3.0 | 4 | ASTM D1682-D1117 |
| kg | 3.0 | 4.1 | |
| Peeling Strength | 1.0 | 1.7 to 1.8 | ASTMD751 |
| Kg/cm | | | |
| Flameproof | Burnt on ignition, | Less than | FMVSS302 |
| Ability | more than 20 cm | 2 cm in 15 | |
| | in 15 seconds | seconds | |

### Second Embodiment

Releasing paper is coated with a layer of polyurethane resin with solid content of 12.5% (including 87.5% of solvent). The stickiness of the polyurethane resin is controlled at 1300 cps/30° C. The polyurethane resin is baked in a stove at a temperature of 110° C. in order to form a surface layer.

High solid-content polyurethane resin is coated on the surface layer. The high solid-content polyurethane resin includes 40% of polyurethane resin (with solid content of 83%), 12% of phosphorous flameproof agent and Sb₂O₃ (phosphorous: Sb₂O₃ is 2:1), 0.5% of interface agent, 7% of curing agent, 38.5% of filling agent and 2% of dye. The stickiness of the high solid-content polyurethane resin is controlled at 25000 cps/30° C. The polyurethane resin is baked in a stove at a temperature of 130° C. in order to form an intermediate layer.

Polyurethane resin with solid content of 35% is coated on the intermediate layer in order to form an adhesive layer. The polyurethane resin of the adhesive layer is dried a little in the stove. When the adhesive layer is still sticky, a layer of 100% PET that is made with thickness of 1.0 mm and processed with water-based flameproof agent is adhered to it. The polyurethane resin of adhesive layer is dried in the stove. Then, the releasing paper is removed by means of a cooling wheel. Thus, artificial leather that possesses volume feeling, high peeling strength and high flexibility and is flameproof is made.

Table 2 shows comparison of the artificial leather of the present invention with the artificial leather discussed in Related Prior Art.

TABLE 2

| | | Present | |
|---|---|---|---|
| | Prior Art | Invention | Test Standard |
| Tensile strength | More than 28 | 30 | ASTM D1682-D1117 |
| kg/cm | More than 10 | 21 | |
| Elongation % | More than 80 | 112 | ASTM D1682-D1117 |
| | More than 120 | 128 | |
| Tearing Strength | More than 3.0 | 3 | ASTM D1682-D1117 |
| kg | 3.0 | 3.1 | |
| Peeling Strength | 1.0 | 1.2 | ASTMD751 |
| Kg/cm | | | |
| Flameproof | Burnt on ignition, | Less than | FMVSS302 |
| Ability | more than 20 cm | 2 cm in 15 | |
| | in 15 seconds | seconds | |

From Tables 1 and 2, it is learned that the flameproof environmentally friendly artificial leather of the present invention is better than the artificial leather discussed in Related Prior Art regarding various physical properties including stripping strength. The process of the present invention requires only a little or no organic solvent and is flameproof. Therefore, it ensures human health and safety and environmental protection.

The present invention has been described via detailed illustration of some embodiments. Those skilled in the art can derive variations from the embodiments without departing from the scope of the present invention.

Therefore, the embodiments shall not limit the scope of the present invention defined in the claims.

1. A process for making flameproof environmentally friendly artificial leather, the process comprising the steps of:
coating releasing paper with a first kind of polyurethane resin compound in order to form a surface layer;
mixing chlorine-free flameproof agent, polyurethane resin compound with solid-content higher than 50% and curing agent in order to make high solid-content polyurethane resin compound;
coating the high solid-content polyurethane resin compound on the surface layer in order to form an intermediate layer;
coating the intermediate layer with an adhesive layer;
adhering a substrate to the adhesive layer in order to form a half-product of the flameproof environmentally friendly artificial leather; and removing the releasing paper from the surface layer in order to form the flameproof environmentally friendly artificial leather.

2. The process according to claim 1 wherein the first polyurethane resin compound is one of water-dissolvable polyurethane resin compound, water-dispersed polyurethane resin compound.

3. The process according to claim 1 wherein the first polyurethane resin compound is oil-based polyurethane resin compound.

4. The process according to claim 1 wherein the flameproof agent is selected from a group comprising antimony-containing flameproof agent, phosphorous flameproof agent, calcium carbonate and clay.

5. The process according to claim 1 wherein the high solid-content polyurethane resin compound comprises 65% to 85% of solid content, 93% to 98% polyurethane resin, 0% to 2% interface agent, 3% to 7% of curing agent, 0% to 10% of dye and 10% to 25% of chlorine-free flameproof agent.

6. The process according to claim 1 wherein the second polyurethane resin compound is one of water-dissolvable polyurethane resin compound water-dispersed polyurethane resin compound, and solvent-free vapor-coagulated polyurethane resin compound.

7. The process according to claim 1 wherein the substrate is one of cloth, non-woven cloth, and animal leather.

8. A process for making flameproof environmentally friendly artificial leather, the process comprising the steps of:
providing mixture of 10% to 40% of polyol, 15% to 25% of isocyanate 15% to 35% chain-extending agent and chlorine-free flameproof agent in an impact-type mixing head of a reactive injection molding apparatus;
pre-polymerizing the gradients;
adding 15% to 25% of isocyanate in the impact-type mixing head in order to form the precursor of the polyurethane (the isocyanates index NCO/OH is 0.9 to 1.2);
coating the precursor on the releasing paper under injection pressure of lower than 4 kgf/cm2;
heating the precursor in a stove kept at a temperature of 70° C. to 180° C. in order to form the polyurethane resin;
adhering a substrate to the polyurethane resin;
heating the polyurethane resin in the stove so that it is coagulated and that a half-product of the flameproof environmentally friendly artificial leather is made; and
removing the releasing paper from the polyurethane resin so that the flameproof environmentally friendly artificial leather is made.

9. The process according to claim 8 wherein the polyol is polyalkyldiol with unsaturated of less than 0.05 meq/g and molecular number of 1000 to 3000.

10. The process according to claim 8 wherein the isocyanate is selected from a group consisting of diphenylmethanediisocynate (MDI), tolulenediisonate (TDI), modifer, and mixtures thereof.

11. The process according to claim 8 wherein the chain-extending agent is selected from a group consisting of ethylene golycol, 1.4-butanediol, beopentyl glycol, 1.6-hexanediol, diethylene glycol, triethylene glycol, dipropylene glycol, triethanolamine, N-diethanolamide, N-alkyldiethylamino, and mixtures thereof.

12. The process according to claim 8 wherein the flameproof agent is selected from a group comprising antimony-containing flameproof agent, phosphorous flameproof agent, calcium carbonate and clay.

13. The process according to claim 8 wherein the substrate is one of cloth, non-woven cloth, and animal leather.

14. Flameproof environmentally friendly artificial leather comprising:
a substrate;
an adhesive layer coated on the substrate, wherein the adhesive layer is made of a first kind of polyurethane resin compound;
an intermediate layer coated on the adhesive layer, wherein the intermediate layer is made of high solid-content polyurethane resin compound; and
a surface layer coated on the intermediate layer, wherein the surface layer is made of a second polyurethane resin compound.

15. The artificial leather according to claim 14 wherein the substrate is one of cloth, non-woven cloth, and animal leather.

16. The artificial leather according to claim 14 wherein the first polyurethane resin compound is one of water-dissolvable polyurethane resin compound water-dispersed polyurethane resin compound, and solvent-free vapor-coagulated polyurethane resin compound.

17. The artificial leather according to claim 14 wherein the high solid-content polyurethane resin compound comprises 65% to 85% of solid content, 93% to 98% polyurethane resin, 0% to 2% interface agent, 3% to 7% of curing agent, 0% to 10% of pigment and 10% to 25% of chlorine-free flameproof agent.

18. The artificial leather according to claim 14 wherein the flameproof agent is selected from a group comprising antimony-containing flameproof agent, phosphorous flameproof agent, calcium carbonate and clay.

19. The artificial leather according to claim 14 wherein the second polyurethane resin compound is one of water-dissolvable polyurethane resin compound and water-dispersed polyurethane resin compound.

20. The artificial leather according to claim 14 wherein the second polyurethane resin compound is made with solid-content of 10% to 90%.
